(19) United States
(12) Patent Application Publication
(10) Pub. No.: US 2016/0235077 A1
(43) Pub. Date: Aug. 18, 2016

(54) SHELF-STABLE COMPOSITIONS DERIVED FROM POULTRY AND METHOD OF THEIR MAKING

(71) Applicant: INTERNATIONAL DEHYDRATED FOODS, INC., Springfield, MO (US)

(72) Inventors: Roger L. DAKE, Springfield, MO (US); Jack CAPPOZZO, Springfield, MO (US); Stephanie LYNCH, Springfield, MO (US)

(21) Appl. No.: 15/045,578

(22) Filed: Feb. 17, 2016

Related U.S. Application Data
(60) Provisional application No. 62/117,239, filed on Feb. 17, 2015.

(51) Int. Cl. A23B 4/01

(52) U.S. Cl. CPC A23B 4/012; A23L 1/315; A23V 2002/00

(57) ABSTRACT

Disclosed here are methods of preparing and delivering shelf stable products derived from poultry or other animal sources. The products are maintained at certain elevated temperature so that it may be pasteurized during transportation and/or storage and may be considered free or substantially free of pathogens at the destination.

### RELATED APPLICATION

This application claims priority to U.S. Patent application 62/117,239, filed Feb. 17, 2015, the entire content of which is hereby incorporated by reference into this application.

### BACKGROUND

1. Field of the Invention

This disclosure relates to food products derived from animal sources and methods of preparing the same.

2. Description of Related Art

Poultry derived products such as chicken soup or chicken broth provide various benefits to human health. It is important to ensure that the manufactured products are free from pathogenic microorganisms such as Salmonella.

Various ingredients from poultry or other animals may be mixed to make a final product. Examples of these ingredients may include but are not limited to dried chicken, rendered poultry meals, and fats. Individual ingredient may be contaminated by Salmonella and other microorganisms. Even if individual ingredient is free from contamination, the product may be contaminated during mixing, storage and transportation.

### SUMMARY

The present disclosure advances the art by providing methods to manufacture the products that are free or substantially free from pathogenic microorganisms.

In one embodiment, methods to deliver shelf stable ingredients derived from poultry or other animal sources are disclosed. In one aspect, the ingredients may be packaged and protected such that the product in the delivery package is the equivalent of pasteurized product and is considered salmonella free. According to one embodiment of the disclosure, this streamlined process may help minimize introduction of Salmonella or other microorganisms of concern into the manufacturing environment. In another embodiment, the disclosed process may allow direct addition of the ingredient into the processing stream without the need for additional treatment to ensure product safety.

In one embodiment, the process for making the disclosed product may include receiving and collecting raw materials, cooking the raw materials, separating liquid fractions from solid fractions and separating fat from the water based fractions. In one aspect, the water insoluble solids may be dried separately. In another aspect, the fat may be clarified and dewatered, and the fat and the dried water insoluble solids are re-combined. In another embodiment, the dried solids are shelf stable and the clarified/dewatered fat are also shelf stable. Therefore, the combined product is also shelf stable.

The disclosed process is different from existing processes used in the industry. In a typical process currently in use, the poultry and parts are batch cooked but the different fractions are not separated. By contrast, in one aspect of the instant disclosure, the different fractions are separated after cooking. Also, in existing processes, the poultry and parts are typically cooked until all the water is boiled away, resulting in a product that still contains the water soluble components. By contrast, in one aspect of the instant disclosure, water is not boiled away so that the water soluble components remain in the aqueous phase.

In another embodiment, the dried insoluble solids and fat are heated to a temperature known to kill vegetative bacteria. The heated material may then be filled hot into totes or other appropriate packaging or transportation containers, which may be sealed to prevent recontamination. The materials may be held hot for such time as required to effect the degree of bacterial kill desired. Examples of such bacteria may include but are not limited to Salmonella, E. coli or other pathogens of concern.

In another embodiment, a process for making a shelf stable product derived from an animal or poultry source is disclosed, which may include the steps of (a) mixing two or more ingredients in a container, wherein at least one ingredient is derived from the animal or poultry source; and (b) transporting the container while maintaining the mixture in the container at a temperature of 40° C. or higher during transportation.

A process for making a shelf stable composition is disclosed, which may include the steps of (a) loading a starting composition into a container, wherein said starting composition comprises one or more ingredients, and wherein at least one ingredient of said starting composition is derived from an animal source, (b) transporting the container containing the starting composition from a first location to a second location, wherein the starting composition is maintained at a temperature of 40° C. or higher during transportation, and (c) obtaining said shelf stable composition from the container at the second location.

In one aspect, the temperature of the mixture in the container during the transportation is between about 40° C. and about 120° C. In another aspect, the temperature is between about 40° C. and about 110° C. In another aspect, the temperature is between about 49° C. and about 100° C. In another aspect, the temperature is between about 60° C. and about 100° C. In another aspect, the temperature is between about 80° C. and about 100° C.

In one embodiment, a shelf stable composition is disclosed, which may comprise a first ingredient and a second ingredient, wherein the first ingredient is dried poultry or poultry meals, and the second ingredient is oil and/or fat derived from an animal or plant source, said composition being prepared by (a) loading a starting composition comprising the first and second ingredients into a container, and (b) transporting the container containing the starting composition from a first location to a second location, wherein the starting composition is maintained at a temperature of 40° C. or higher during transportation. The shelf stable composition may be obtained from the container at the end of the transportation at the second location.

In another embodiment, the starting composition may have two or more ingredients which are mixed in the container before, after, and/or during the transportation.

In another embodiment, the total number of pathogen in the shelf stable composition obtained in (c) is at least 3-fold lower than the total number of pathogen in the starting composition in (a). In one aspect, the total number of pathogens in the shelf stable composition obtained in (c) is at least 2-fold, 5-fold, 10-fold, or 100-fold lower than the total number of pathogen in the starting composition in (a). Examples of pathogens may include but are not limited to bacterium, fungus, virus or combination thereof. Examples of bacteria may include but are not limited to E. coli, Salmonella, Listeria, Clostridium botulinum, Campylobacter, Shigella, Yersinia, Arcobacter or combination thereof. In one aspect, the total number of Salmonella in the shelf stable composition obtained in (c) is at least 2-fold, 3-fold, 5-fold, 10-fold, or 100-fold lower than the total number of Salmonella in the starting composition in (a).

In one aspect, the shelf stable composition obtained in (c) is substantially free from salmonella. In another embodiment, the shelf stable composition obtained in (c) is substantially free from Salmonella. In another aspect, the starting composition in (a) may already be substantially free of pathogens, or the two or more ingredients are shelf stable prior to being mixed in the container, but the disclosed process may help prevent contamination of the mixture during transportation in (b) by maintaining the temperature of the mixture at 40° C. or higher during transportation.

In another embodiment, the lipid fraction may be the fat removed from the product stream described above or it may be an equivalent proportion of fat from a collected inventory or a different source. In one embodiment, the fat may be derived from an animal source. In another embodiment, the fat may be replaced in whole or in part with a plant-derived oil. Examples of the plant-derived oil may include but are not limited to soybean oil, corn oil, canola oil, coconut oil, among others.

In one embodiment, the ingredients may be prepared from an animal, such as poultry. Examples may include but are not limited to chicken, turkey, or other birds. In another embodiment, the ingredients may be prepared by using parts from other animal sources.

In another embodiment, the starting composition may be mixture of at least two ingredients: a first ingredient and a second ingredient, wherein the first ingredient is dried poultry or poultry meals, and the second ingredient is oil and/or fat derived from an animal or plant source.

In another embodiment, the distance between the first location and the second location is between 10 and 1,000 kilometers, between 20 and 400 kilometers, or between 20 and 200 kilometers.

In another embodiment, the disclosed compositions may comprise about 10-80% protein and about 10-80% fat, all by weight, and the animal source is chicken. In one specific embodiment, the disclosed composition may comprise about 50.7% protein, about 42.2% fat, and about 2.8% ash, all by weight. In another embodiment, the disclosed composition may comprise about 44.5% (w/w) protein, about 37.6% (w/w) fat, and about 12.6% (w/w) ash. In another embodiment, the disclosed compositions may have a water activity of less than 0.6.

The compositions disclosed herein may be characterized by the unique composition as described herein. The disclosed compositions may also be characterized by the methods by which they are prepared.

### DETAILED DESCRIPTION

Poultry derived products such as chicken soup or chicken broth provide various benefits to human health. In preparing a final product from poultry, different ingredients may sometimes be prepared at different locations and then mixed to make the final product. These different ingredients may also be transported to a different location to make the final products. In one embodiment, transportation may occur before or after the mixing of the different ingredients. Examples of such ingredients may include but are not limited to dried chicken, rendered poultry meals, and fats, among others.

In one embodiment, these ingredients may be cooked sufficiently to kill Salmonella and other microorganisms. However, the materials may be re-contaminated during storage and shipping, especially when shipped in bulk in open top truck-trailers that are covered by a roll-over canvas and/or are emptied through non-aseptic means.

Disclosed here are methods to deliver shelf stable ingredients derived from poultry or other animal sources. In one embodiment, the ingredients may be packaged and protected so that the product in the delivery package is the equivalent of pasteurized product and can be considered salmonella free. According to one embodiment of the disclosed methods, this streamlined process helps minimize introduction of salmonella and other microorganisms of concern into the manufacturing environment, and allow direct addition of the ingredient into the processing stream without the need for additional treatment to ensure product safety.

As used herein, the term “animal” may include but are not limited to cattle, cow, pig, sheep, goat, poultry, fish, among others.

The term “container” may refer to standalone containers or bags for holding the mixture, as well as vessels that are mounted on a vehicle. Examples of containers may include but are not limited to totes, boxes, super sacks, bags, vessels, truck trailers or combination thereof. In one aspect, the container is a closed container. In another aspect, the container is an open container. In one embodiment of this disclosure, the container may have at least one heating means for maintaining the mixture at an elevated temperature. In another embodiment of this disclosure, the container may comprise a means for reducing the number of pathogens in the mixture. By way of example, in one aspect of this disclosure, certain physical means (e.g., heating, radiation, lighting, etc.) for killing virus, bacteria, and/or fungus may be built into the container. In another aspect, the container may also contain a mechanism for mixing the ingredients during transportation.

The terms “broth” and “soup” refer to a liquid composition containing at least one solute and may also be used to refer to a ready to serve form, a concentrate, a stock in either liquid or solid form.

The term “shelf stable” refers to a composition that may be safely stored at room temperature without being spoiled for an extended period of time, for example, for at least 10 days, or longer.

The term “dry solid” or “solid” as used herein refers to the components of a liquid composition that remain after all free liquid is removed from the liquid composition. In the case of an aqueous broth, the free liquid is water.

The term “not detectable” means a chemical or biological ingredient that may be present in such a small amount that it cannot be measured by currently available analytic instruments.

The term “substantially free” means that the number of a certain subject is so low in a composition that it is negligible. For example, a food product that is substantially free from a pathogen means the amount of the pathogen (including its spores, if any) is so low that it is generally considered safe to consume by humans.

### EXAMPLES

The following examples are provided for purposes of illustration of the embodiments only and are not intended to be limiting. The raw materials, reagents, chemicals, and other materials are presented as exemplary components or reagents, and various modifications may be made in view of the foregoing discussion within the scope of this disclosure. Unless otherwise specified in this disclosure, components, reagents, protocol, and other methods used in the system and the assays, as described in the Examples, are for the purpose of illustration only.

### Example 1

### Pasteurization During Transportation of Poultry-Derived Products

Dried, milled chicken parts (400 grams) were blended with warm shelf stable chicken fat (164 grams) and mixed thoroughly in a small container. The resultant warm mixture was highly flowable and pumpable. Although the mixture appeared thick and viscous, it could be dumped from a large container such as a tote. The mixture also could be pumped using an air piston pump, and could be conveyed in standard plant augers or other similar equipments known in the art.

By heating the mixture to more than 200° F. (i.e., about 93.3° C.) and holding for 6 hours or more during transportation, the total number of pathogens (e.g., Salmonella) in the mixture is substantially reduced. At the destination, the mixture may be considered free or substantially free from pathogens (e.g., Salmonella).

### Example 2

### Preparation of Shelf Stable Products With Specific Ingredients

Dried chicken or turkey in the form of a milled particle is used as starting materials. Particle size is roughly the size of corn meal but may be larger or smaller according to needs. This dried poultry product is blended with an amount of fat that makes it pumpable using special pumps like a Graco air piston pump or equivalent.

Additional ingredients are blended into the product to obtain a specified percentage of fat, protein, moisture, and ash, according to needs. Also, one or more antioxidants may be blended into fat (or oil) before mixing with the dried chicken.

The product is heated to a specified temperature and held for a specified time to achieve pasteurization. A Salmonella-free finished packaged product is made by filling the heated blend into shipping totes or other containers including bulk trailers. The product is effectively pasteurized during the time of shipping at the heated temperature. Accordingly, specific guarantees may be made regarding contents of pathogenic bacteria or other microorganisms.

The product may then be stored at ambient temperature. Because the water activity is very low, there is little chance of microbial growth. Alternatively, the product upon receipt by the customer packing plant may be transferred into the manufacturing system.

The presently disclosed processes may be applicable to various compositions and ingredients disclosed in U.S. Patent applications U.S. patent application Ser. Nos. 14/210,284, and 14/325,694, and PCT application Nos. PCT/US2015/027934, PCT/US2015/027978, and PCT/US2015/027986, all of which are hereby incorporated into this disclosure as if fully reproduced herein.

Changes may be made in the above methods and systems without departing from the scope hereof. It should thus be noted that the matter contained in the above description or shown in the accompanying drawings should be interpreted as illustrative and not in a limiting sense. The following claims are intended to cover generic and specific features described herein, as well as statements of the scope of the present method and system, which, as a matter of language, might be said to fall there between.

Although each of the embodiments described above has been illustrated with various components having particular respective orientations, it should be understood that the system and methods as described in the present disclosure may take on a variety of specific configurations with the various components being located in a variety of positions and mutual orientations and still remain within the spirit and scope of the present disclosure. Furthermore, suitable equivalents may be used in place of or in addition to the various components, the function and use of such substitute or additional components being held to be familiar to those skilled in the art and are therefore regarded as falling within the scope of the present disclosure. Therefore, the present examples are to be considered as illustrative and not restrictive, and the present disclosure is not to be limited to the details given herein but may be modified within the scope of the appended claims.

All references cited in this disclosure, including patents, patent applications, scientific papers and other publications, are hereby incorporated by reference into this application.

We claim:

1. A process for making a shelf stable composition comprising:
(a) loading a starting composition into a container, wherein said starting composition comprises one or more ingredients, and wherein at least one ingredient of said starting composition is derived from an animal source;
(b) transporting the container containing the starting composition from a first location to a second location, wherein the starting composition is maintained at a temperature of 40° C. or higher during transportation; and
(c) obtaining said shelf stable composition from the container at the second location.

2. The process of claim 1, wherein said starting composition comprises two or more ingredients wherein said two or more ingredients are mixed in the container.

3. The process of claim 1, wherein total number of pathogen in said shelf stable composition obtained in (c) is significantly lower than total number of pathogen in said starting composition in (a).

4. The process of claim 3, wherein said pathogen is at least one member selected from the group consisting of bacterium, fungus, virus and combination thereof.

5. The process of claim 1, wherein total number of pathogen in said shelf stable composition obtained in (c) is at least 3-fold lower than total number of pathogen in said starting composition in (a), said pathogen being at least one member selected from the group consisting of E. coli, Salmonella, Listeria, Clostridium botulinum, Campylobacter, Shigella, Yersinia, Arcobacter and combination thereof.

6. The process of claim 1, wherein total number of Salmonella in said shelf stable composition obtained in (c) is at least 3-fold lower than total number of Salmonella in said starting composition in (a).

7. The process of claim 1, wherein said shelf stable composition obtained in (c) is substantially free from Salmonella.

8. The process of claim 1, wherein said starting composition in (a) is substantially free of pathogens, said process preventing contamination of said composition during transportation in (b).

9. The process of claim 1, wherein the containers is selected from the group consisting of totes, boxes, super sacks, bags, truck trailers and combination thereof.

10. The process of claim 1, wherein the shelf stable composition obtained in (c) is pumpable.

11. The process of claim 2, wherein the two or more ingredients are shelf stable prior to being mixed in the container.

12. The process of claim 1, wherein said starting composition comprises a first ingredient and a second ingredient, said first ingredient being dried poultry or poultry meals, and said second ingredient being oil and/or fat derived from an animal or plant source.

13. The process of claim 1, wherein the temperature is between about 40° C. and about 110° C.

14. The process of claim 1, wherein the temperature is between about 60° C. and about 100° C.

15. The process of claim 1, wherein the distance between the first location and the second location is at least 20 kilometers.

16. A shelf stable composition prepared according to the process of claim 1, comprising about 10-80% (w/w) protein and about 10-80% (w/w) fat, wherein said animal source is chicken.

17. The composition of claim 16, comprising about 50.7% (w/w) protein, about 42.2% (w/w) fat, and about 2.8% (w/w) ash.

18. The composition of claim 16, comprising about 44.5% (w/w) protein, about 37.6% (w/w) fat, and about 12.6% (w/w) ash.

19. The composition of claim 16, said composition having water activity of less than 0.6.

20. A shelf stable composition comprising a first ingredient and a second ingredient, said first ingredient being dried poultry or poultry meals, and said second ingredient being oil and/or fat derived from an animal or plant source, said composition being prepared by (a) loading a starting composition comprising the first and second ingredients into a container, and (b) transporting the container containing the starting composition from a first location to a second location, wherein the starting composition is maintained at a temperature of 40° C. or higher during transportation, wherein said shelf stable composition is obtained from the container at the second location.
